(19) United States
(12) Patent Application Publication
(10) Pub. No.: US 2003/0236858 A1
(43) Pub. Date: Dec. 25, 2003

(54) Multimedia contents creating apparatus and multimedia contents creating method

(76) Inventors: Akio Nishiyama, Asaka-shi (JP); Daisuke Sano, Kawasaki-shi (JP)

Correspondence Address: BIRCH STEWART KOLASCH & BIRCH, PO BOX 747, FALLS CHURCH, VA, 22040-0747, US

(21) Appl. No.: 10/430,428

(22) Filed: May 7, 2003

(30) Foreign Application Priority Data
May 7, 2002 (JP) P. 2002-131705

(51) Int. Cl. G06F 15/16

(52) U.S. Cl. 709/217; 709/206

(57) ABSTRACT

The present invention provides a multimedia contents creating apparatus and a multimedia contents creating method are provided, which are capable of opening multimedia contents on a Web by a simple manner even in such a case that a user uses a compact terminal. In the apparatus, a mail relay server receives/repeats a first electronic mail transmitted from a mail transmitting terminal, and also, separates both a mail main text and an attached file from the first electronic mail. A contents creating device converts file data of the attached file into a composite multimedia content. A Web server 2 opens this composite multimedia content as a Web page. A second electronic mail constituted by the above-explained mail main text and a URL of the above-described Web page is created in the mail relay server, and then, this created second electronic mail is transmitted to a mail receiving terminal.

### BACKGROUND OF THE INVENTION

1. Field of the Invention

The present invention is related to a multimedia contents creating apparatus and a multimedia contents creating method, by which if an electronic mail to which a plurality of contents have been attached is transmitted, then a multimedia content constructed of these plural contents may be created and may be opened on a Web server.

2. Description of the Related Art

A conventional method for opening a multimedia content constituted by a plurality of contents on a Web will now be described, while the multimedia content will also be referred to as a “composite multimedia content”. First, a composite multimedia content is created on the user side by employing the HTML (Hyper Text Markup Language) language and the like, while a plurality of contents are employed as materials. Then, an electronic mail to which this composite multimedia content has been attached is transmitted to a predetermined server from the user side. When the predetermined server receives this electronic mail, this server separates a mail main text from the composite multimedia content corresponding to the attached file, and then stores this separated composite multimedia content into a Web server.

At this time, since a URL (Uniform Resource Locator) indicative of a location (address) where the composite multimedia content has been stored is applied, the predetermined server transmits an electronic mail on which this URL has been described to a predetermined user. As a consequence, if the user accesses the above-described URL by employing such a terminal accessible to the Web server, then this user can view the composite multimedia content.

However, in the above-explained conventional multimedia opening method, the user is required to create the composite multimedia content based upon a plurality of contents. In such a case that the user utilizes a compact terminal such as a portable telephone and a PDA (Personal Digital Assistants), the user cannot easily create this composite multimedia content, because of a screen size, a functional characteristic, an operability, and the like as to this compact terminal. Even when a tool for creating the composite multimedia content has been installed in this compact terminal, the operability of this compact terminal is inferior to that of such a terminal as a personal computer.

### SUMMARY OF THE INVENTION

The present invention has been made to solve the above-described aspects and problem of the prior art, and therefore, has an object to provide both a multimedia contents creating apparatus and a multimedia contents creating method, which are capable of opening multimedia contents on a Web by a simple manner even in the case that a user uses a compact terminal.

To achieve the above-described object, a multimedia contents creating apparatus, according to the present invention, is comprised of: contents separating means operated in such a manner that when a first electronic mail to which at least one content has been attached is received, the first electronic mail is separated into both a mail main text and the attached content; and multimedia contents creating means for creating a multimedia content containing the separated content by using a predetermined template, and for registering the created multimedia content into a Web server. As a consequence, since the contents as materials of the multimedia content are merely transmitted and the multimedia content need not be created on the user side, even in such a case that the user uses a compact terminal such a portable telephone and a PDA, the screen size, the functional characteristic, and the operability of which are inferior to those of a terminal such as a personal computer, the multimedia content can be registered into the Web server by a simple manner.

Also, the multimedia contents creating apparatus, according to the present invention, is further comprised of: electronic mail processing means for creating a second electronic mail containing both the mail main text and a URL which has been applied when the multimedia content is registered into the Web server, and also for transmitting the created second electronic mail to either a destination designated by the first electronic mail or a transmission source of the first electronic mail. As a consequence, if the user receives the electronic mail on which the URL of the multimedia content has been described, then the user can access the Web server based upon the URL described on this electronic mail, so as to view the multimedia content.

Also, in the multimedia contents creating apparatus according to the present invention, the multimedia contents creating means registers the separated content into the Web server, and writes URLs of the respective contents applied when the separated content is registered in the Web server into the template so as to create the multimedia content.

Also, in the multimedia contents creating apparatus according to the present invention, the template is a program described by way of an SMIL (Synchronous Multimedia Integration Language) language, and owns such a portion into which the URLs of the contents can be inputted every content.

Also, a multimedia contents creating method, according to the present invention is comprised of: an electronic mail receiving step for receiving a first electronic mail to which at least one content has been attached; a contents separating step for separating the first electronic mail into both a mail main text and the attached content; a multimedia contents creating step for creating a multimedia content containing the separated content by using a predetermined template; and an uploading step for registering the created multimedia content into a Web server.

Also, the multimedia contents creating method, according to the present invention, is further comprised of: an electronic mail creating step for creating a second electronic mail containing both the mail main text and a URL which has been applied when the multimedia content is registered into the Web server; and an electronic mail transmitting step for transmitting the second electronic mail created in the electronic mail creating step to either a destination designated by the first electronic mail received in the electronic mail receiving step or a transmission source of the first electronic mail.

Furthermore, in the multimedia contents creating method according to the present invention, the multimedia contents creating step includes: a contents registering step for registering the separated content into the Web server; and a URL writing step for writing URLs of the respective contents applied when the separated content is registered into the Web server in the contents registering step.

### BRIEF DESCRIPTION OF THE DRAWINGS

FIG. 1 is a block diagram for showing a multimedia contents creating apparatus according to an embodiment mode of the present invention;

FIG. 2 is an explanatory diagram for representing a description example of a template by way of the SMIL language so as to create a composite multimedia content;

FIG. 3 is an explanatory diagram for indicating a description example of the multimedia content created by employing the template shown in FIG. 2;

FIG. 4 is a sequential operation chart for explaining operations of the multimedia contents creating apparatus according to one embodiment mode of the present invention;

In the figures, the reference numeral 1 refers to a mail transmission terminal; 2 to a mail relay server; 3 to a contents creating apparatus; 4 to a Web server; and 5 to a mail receiving terminal.

### DETAILED DESCRIPTION OF THE PREFERRED EMBODIMENTS

Various embodiment modes of multimedia contents creating apparatus according to the present invention will now be described in detail. When the multimedia contents creating apparatus of this embodiment mode receives such an electronic mail to which a plurality of contents have been attached, this multimedia contents creating apparatus creates a multimedia content constituted by these plural contents (will also be referred to as a “composite multimedia content” hereinafter), and then opens this composite multimedia content on a Web.

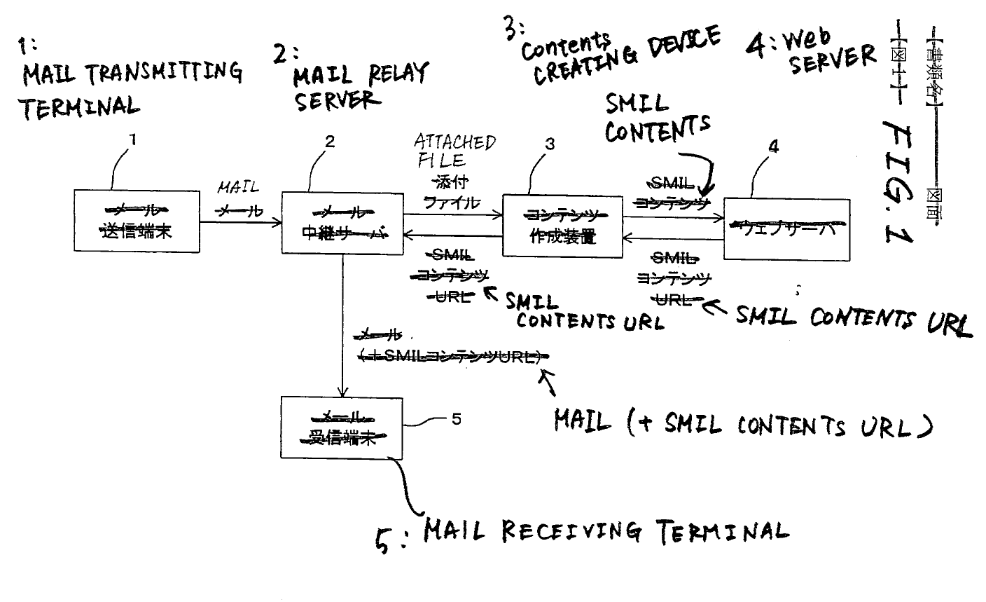

FIG. 1 is a schematic block diagram for indicating a multimedia contents creating apparatus according to an embodiment mode of the present invention. The multimedia contents creating apparatus shown in this drawing is arranged by employing a mail transmitting terminal 1, a mail relay server 2, a contents creating apparatus 3, a Web server 4, and a mail receiving terminal 5. The mail relay server 2 corresponds to both a content separating means and an electronic mail processing means, as defined in the scope of patent claims. The contents creating apparatus 3 corresponds to a multimedia contents creating means. It should be noted that either all or a portion of the above-explained mail relay server 2, contents creating apparatus 3, and Web server 4 may be alternatively arranged within the same apparatus.

The respective structural elements contained in the multimedia contents creating apparatus according to this embodiment mode will now be explained.

First, the mail transmitting terminal 1 is explained. The mail transmitting terminal 1 is employed so as to transmit an electronic mail via an network (not shown) to the mail relay (relaying) server 2. This electronic mail corresponds to a first electronic mail as defined in the scope of patent claims, and a plurality of contents prepared by a user have been attached to this electronic mail. These contents attached to this electronic mail are a text file, a document file equipped with a form, an image file, a moving image file, a voice (speech) file, and so on. Alternatively, the contents attached to this electronic mail may be such a file made by compressing, or encrypting a plurality of contents in a combination manner.

Next, the mail relay server 2 will now be described. When the mail relay server 2 receives an attached mail which is transmitted from the transmitting terminal 1, namely receives the electronic mail to which a plurality of contents have been attached, the mail relay server 2 separates this attached file into a mail main text and an attached file (namely, contents as materials), and then, transmits the attached file to the contents creating apparatus 3. It should be noted that if an attached file has been compressed, or encrypted, then the mail relay server 2 expands this compressed, or encrypted attached file before transmitting this attached file to the contents creating apparatus 3.

Also, the mail relay server 2 transmits such an electronic mail corresponding to a second electronic mail as defined in the scope of patent claim, and this electronic mail contains both a URL of a composite multimedia content and a main text of the attached mail transmitted from the mail transmitting terminal 1. The composite multimedia content has been created by the contents creating apparatus 3 (will be explained later), and also has been registered in the Web server 4. It should also be noted that this electronic mail may be alternatively transmitted to the mail transmitting terminal 1 in addition to the mail receiving terminal 5.

Next, a description will now be made of the contents creating apparatus 3. The contents creating apparatus 3 is employed so as to create a composite multimedia content by using an attached file transmitted from the mail relay server 2 as a material. In this embodiment mode, a composite multimedia content is created by using an SMIL (Synchronous Multimedia Integration Language) language, and a preset template is employed.

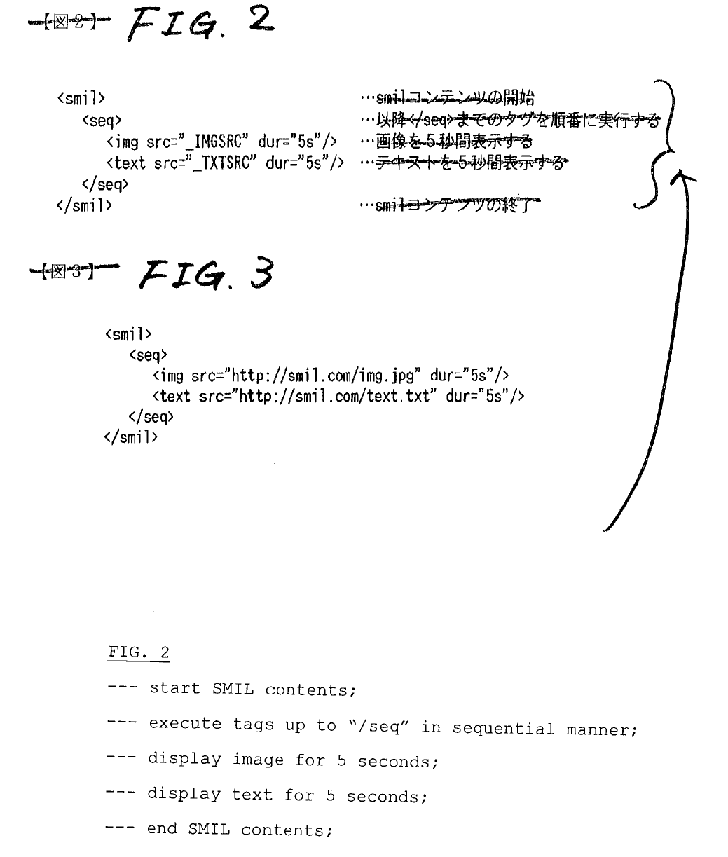

FIG. 2 represents a description example of a template by the SMIL language used to create a composite multimedia content. The template indicated in this drawing shows a program used to repeatedly indicate such an operation that an image is displayed for 5 seconds, and a text is displayed for 5 seconds. It should also be noted that the template shown in this drawing is one of examples. In such a case that the contents creating device 3 owns plural sorts of such templates, a user may select one of these plural sorts of templates.

When the contents creating device 3 creates a composite multimedia content by using the templates, the contents creating device 3 registers the respective contents which have been attached to an electronic mail into the Web server 4. When the contents are registered into the Web server 4, since URLs are given to the respective contents, the contents creating apparatus 3 writes the URLs given to the respective contents into a predetermined template, and then sets this written template as an SMIL file of the composite multimedia content. In other words, since the contents creating device 3 writes the URLs of the respective contents into the predetermined template so as to create the SMIL file, such a composite multimedia content may be created.

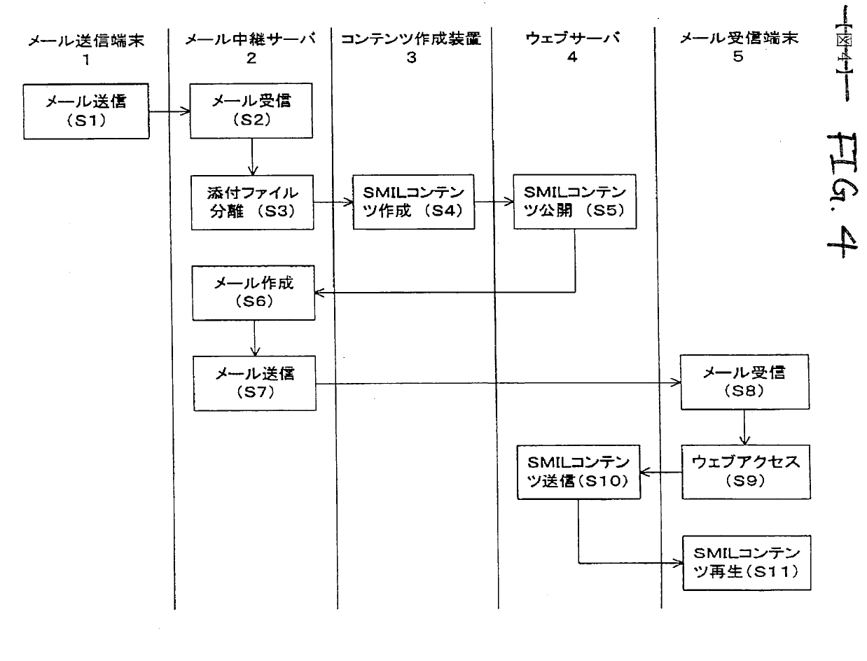

FIG. 3 indicates a description example of a composite multimedia content which has been created by employing the template shown in FIG. 2. The composite multimedia content indicated in this drawing is constituted by two contents, namely both an image file, the file name of which is “image.jpg”, and a text file, the file name of which is “text.txt”. When this composite multimedia content is displayed by executing viewing software such as a browser, both the image of “image.jpg” and the text of “text.txt” are displayed respectively for 5 seconds in a repetition manner.

The contents creating device 3 registers the composite multimedia content which has been created in the above-described creating manner into the Web server 4 as a file. At this time, since the URL has been given to the composite multimedia content, the contents creating device 3 sends this URL to the mail relay server 2.

Next, the Web server 4 will now be explained. The Web server 4 is employed in order to store contents and composite multimedia contents into a recording medium such as a hard disk, which are sent as materials from the contents creating apparatus 3, and also to transmit the URLs of the respective contents stored in the recording medium to the contents creating apparatus 3. Furthermore, the Web server 4 executes a predetermined process operation with respect to a viewing request which is externally issued.

Next, the mail receiving terminal 5 will now be described. The mail receiving terminal 5 is employed so as to receive an electronic mail in which a URL of a composite multimedia content sent from the mail relay server 2 has been written. A user of this mail receiving terminal 5 may view the composite multimedia content stored in the above-described URL by accessing the Web server 4. In other words, in accordance with the example shown in FIG. 3, both the image of “image.jpg” and the text of “text.txt” are repeatedly displayed respectively for 5 seconds on the display unit of the mail receiving terminal 5.

Next, a description will now be made of operations (multimedia contents creating method) of the multimedia contents creating apparatus according to this embodiment mode with reference to FIG. 4. FIG. 4 is a sequential operation chart for representing the operations of the multimedia contents creating apparatus according to this embodiment mode. The below-mentioned descriptions are made of the following assumption. That is, while a content which has been attached as a material to an electronic mail transmitted from the mail transmission terminal 1 corresponds to an image file having a file name of “image.jpg” and a text file having a file name of “text.txt”, a composite multimedia content is created by employing the template shown in FIG. 2.

First, in a step S1, the mail transmitting terminal 1 transmits an electronic mail having a destination of the user of the mail receiving terminal 5 to the mail relay server 2, while both the image file having the file name of “image.jpg” and the text file having the file name “text.txt” have been attached to this electronic mail Next, in a step S2, the mail relay server 2 receives this transmitted electronic mail. Subsequently, in a step S3, the mail relay server 2 separates the received electronic mail into a mail main text and an attached file, and then, transmits the attached file (namely, both above-described image file and above-described text file) to the contents creating apparatus 3.

Next, in a step S4, the contents creating apparatus 3 creates a composite multimedia content by employing the template shown in FIG. 2, while the above-described attached files are used as material contents, and then, sends this created composite multimedia content to the Web server 4. It should be noted in this step S4, the above-explained attached files are firstly registered into the Web server 4, and the URLs applied to the respective attached files (contents as materials) are obtained, and thereafter, the respective URLs are written into the template, so that the contents creating apparatus 3 creates the composite multimedia content.

Next, in a step S5, since the above-described composite multimedia content is registered to the Web server 4, this composite multimedia content may be brought into an externally viewable condition, and this Web server 4 transmits the URLs applied at this time via the contents creating apparatus 3 to the mail relay apparatus 2. Next, in a step S6, the mail relay server 2 creates such an electronic mail in which the URLs sent from the Web server 4 are contained in a main text thereof. Next, in a step S7, the mail relay server 2 transmits the electronic mail created in the step S6 to the mail receiving terminal 5.

Next, the mail receiving terminal 5 receives the above-described electronic mail in a step S8. Next, in a step S9, the user of the mail receiving terminal 5 accesses the Web server 4 in order to issue a transmission request of the composite multimedia content of the URL described in this electronic mail, namely, a transmission request of both data described by the SMIL language and the linked respective contents (above-explained image file and above-described text file). Next, in a step S10, the Web server 4 transmits the data of the requested contents to the mail receiving terminal 5. As a result, in a step S11, the mail receiving terminal 5 reproduces the composite multimedia content by way of the browser function.

As previously explained, in accordance with the multimedia contents creating apparatus of this embodiment mode, if the electronic mail to which the contents have been attached as the materials is transmitted, then the composite multimedia contents is created by the contents creating device 3 by using the predetermined template by way of the SMIL language, and this created composite multimedia content is registered in the. Web server 4. As a result, this registered composite multimedia content is brought into such a condition that the external user can view this composite multimedia content. Furthermore, since the electronic mail in which the URL of this composite multimedia content has been described is transmitted, a person who receives this electronic mail can access the Web server 4 to view the above-described composite multimedia content.

As previously described, since the composite multimedia content is created by the contents creating device 3 based upon the contents transmitted as the materials and the template, the user may merely transmit the contents as the materials, and need not create the composite multimedia contents. As a result, even in such a case that the user uses the compact terminal such as a portable telephone and a PDA, the user can open the composite multimedia content on the Web by way of the simple manner. The dimension of the screen, the functional characteristic, and the operability of this compact terminal are inferior to those of the terminal such as the personal computer.

It should also be noted that the composite multimedia content has been created by using the SMIL language in this embodiment mode. Alternatively, this composite multimedia content may be created by employing the HTML language, Macromedia Flash, and the like.

As previously explained, in accordance with both the multimedia contents creating apparatus and the multimedia contents creating method of the present invention, since the contents as the materials of the multimedia content are merely transmitted and the multimedia content need not be created on the user side, even in such a case that the user uses the compact terminal such as the portable telephone and the PDA, the screen size, the functional characteristic, and the operability of which are inferior to those of the terminal such as the personal computer, the multimedia content can be registered into the Web server by the simple manner.

What is claimed is:

1. A multimedia contents creating apparatus comprising:
contents separating means operated in such a manner that when a first electronic mail to which at least one content has been attached is received, said first electronic mail is separated into a mail main text and said attached content; and
multimedia contents creating means for creating a multimedia content containing said separated content by using a predetermined template, and for registering said created multimedia content into a Web server.

2. The multimedia contents creating apparatus according to claim 1, further comprising:
electronic mail processing means for creating a second electronic mail containing both said mail main text and a URL which has been applied when said multimedia content is registered into the Web server, and also for transmitting said created second electronic mail to either a destination designated by said first electronic mail or a transmission source of said first electronic mail.

3. The multimedia contents creating apparatus according to claim 1,
wherein said multimedia contents creating means registers said separated content into said Web server, and writes URLs of the respective contents applied when said separated content is registered in the Web server into said template so as to create the multimedia content.

4. The multimedia contents creating apparatus according to claim 2,
wherein said multimedia contents creating means registers said separated content into said Web server, and writes URLs of the respective contents applied when said separated content is registered in the Web server into said template so as to create the multimedia content.

5. The multimedia contents creating apparatus according to claim 3,
wherein said template is a program described by way of an SMIL language, and owns such a portion into which the URLs of said contents can be inputted every content.

6. The multimedia contents creating apparatus according to claim 4,
wherein said template is a program described by way of an SMIL language, and owns such a portion into which the URLs of said contents can be inputted every content.

7. A multimedia contents creating method comprising:
an electronic mail receiving step for receiving a first electronic mail to which at least one content has been attached;
a contents separating step for separating said first electronic mail into both a mail main text and said attached content;
a multimedia contents creating step for creating a multimedia content containing said separated content by using a predetermined template; and
an uploading step for registering said created multimedia content into a Web server.

8. The multimedia contents creating method according to claim 7, further comprising:
an electronic mail creating step for creating a second electronic mail containing both said mail main text and a URL which has been applied when said multimedia content is registered into the Web server; and
an electronic mail transmitting step for transmitting said second electronic mail created in said electronic mail creating step to either a destination designated by said first electronic mail received in said electronic mail receiving step or a transmission source of said first electronic mail.

9. The multimedia contents creating method according to claim 7,
wherein said multimedia contents creating step includes:
a contents registering step for registering said separated content into said Web server; and
a URL writing step for writing URLs of the respective contents applied when said separated content is registered into said Web server in said contents registering step.

10. The multimedia contents creating method according to claim 8,
wherein said multimedia contents creating step includes:
a contents registering step for registering said separated content into said Web server; and
a URL writing step for writing URLs of the respective contents applied when said separated content is registered into said Web server in said contents registering step.

11. A multimedia contents creating apparatus comprising:
a mail relay server for transmitting/receiving an electronic mail and for separating a received electronic mail into a mail main text and a content attached to said electronic mail, if the received electronic mail includes at least a content; and
a contents creating device for creating a multimedia content containing said separated content by using a predetermined template and for registering said created multimedia content into a Web server.

12. The multimedia contents creating apparatus according to claim 11,
wherein said mail relay server creates another electronic mail including said separated mail main text and an URL corresponding to said multimedia content created and registered into a Web server by said contents creating device, and transmits the created electronic mail to a mail receiving terminal.
